(19) United States
(12) Patent Application Publication
(10) Pub. No.: US 2024/0044291 A1
(43) Pub. Date: Feb. 8, 2024

(54) NOISE REDUCTION DEVICE, NOISE REDUCTION METHOD, AND PROGRAM

(71) Applicant: MITSUBISHI HEAVY INDUSTRIES, LTD., Tokyo (JP)

(72) Inventors: Yoshiko Takei, Tokyo (JP); Toshifumi Kudo, Tokyo (JP); Naoki Shino, Tokyo (JP)

(21) Appl. No.: 18/490,971

(22) Filed: Oct. 20, 2023

Related U.S. Application Data
(63) Continuation of application No. PCT/JP2022/014914, filed on Mar. 28, 2022.

(30) Foreign Application Priority Data
Jun. 30, 2021 (JP) 2021-108567

(51) Int. Cl. F02C 7/24; G10K 11/178

(52) U.S. Cl. CPC F02C 7/24; G10K 11/17873; G10K 11/17823; F05D 2260/962

(57) ABSTRACT

A noise reduction device includes: a first waveform acquisition unit configured to acquire, based on a reference signal that is obtained by detecting vibration at a first position of an exhaust duct of a gas turbine, a first waveform representing vibration of the exhaust duct; an unbalanced motor configured to apply, at a second position of the exhaust duct, vibration at a target frequency designated for the exhaust duct; a second waveform acquisition unit configured to acquire, based on a measurement signal obtained by measuring a rotation pulse of the unbalanced motor, a second waveform representing rotation of the unbalanced motor; a setting unit configured to set the target frequency based on the first waveform; and a correction unit configured to correct the target frequency, to achieve a predetermined phase difference between the first waveform and the second waveform.

### TECHNICAL FIELD

The present disclosure relates to a noise reduction device, a noise reduction method, and a program.

This application claims priority based on Japanese Patent Application No. 2021-108567 filed in Japan on Jun. 30, 2021, the contents of which are incorporated herein by reference. This application is a continuation application based on a PCT Patent Application No. PCT/JP2022/014914 whose priority is claimed on Japanese Patent Application No. 2021-108567. The contents of the PCT Application is incorporated herein by reference.

### BACKGROUND ART

Generally, a silencer is used in an exhaust path of a gas turbine to reduce the noise caused by exhaust gas flowing in the exhaust path (see, for example, Patent Document 1). Noise reduction methods employed by such a silencer include a sound absorbing method, a resonance method, an expansion method, and a hybrid method, which are selected as appropriate depending on the characteristics of the noise.

### CITATION LIST

### Patent Document

Patent Document 1: JP 5039684 B

### SUMMARY OF INVENTION

### Technical Problem

Results of various measurements have revealed that low frequency sound produced in an exhaust path of a gas turbine (produced at the time of starting the turbine, for example) is caused by combustion vibration components being radiated toward a duct machine side of the exhaust path. It is not easy to suppress this combustion vibration, which is the source of vibration, because such suppression adversely affects the performance of the gas turbine. Thus, there has been a demand for a technique to suppress the combustion vibration components radiated toward the outside through a gas turbine exhaust system duct.

The present disclosure bas been made in view of such a problem, and provides a noise reduction device, a noise reduction method, and a program that can reduce low frequency sound in an exhaust path of a gas turbine.

### Solution to Problem

A noise reduction device according to an aspect of the present disclosure includes: a first waveform acquisition unit configured to acquire, based on a reference signal that is obtained by detecting vibration at a first position of an exhaust duct of a gas turbine, a first waveform representing vibration of the exhaust duct; an unbalanced motor configured to apply, at a second position of the exhaust duct, vibration at a target frequency designated for the exhaust duct; a second waveform acquisition unit configured to acquire, based on a measurement signal obtained by measuring a rotation pulse of the unbalanced motor, a second waveform representing rotation of the unbalanced motor; a setting unit configured to set the target frequency based on the first waveform; and a correction unit configured to correct the target frequency, to achieve a predetermined phase difference between the first waveform and the second waveform.

A noise reduction method according to an aspect of the present disclosure includes: acquiring, based on a reference signal that is obtained by detecting vibration at a first position of an exhaust duct of a gas turbine, a first waveform representing vibration of the exhaust duct; applying, by an unbalanced motor provided at a second position of the exhaust duct, vibration at a target frequency designated for the exhaust duct; acquiring, based on a measurement signal obtained by measuring a rotation pulse of the unbalanced motor, a second waveform representing rotation of the unbalanced motor; setting the target frequency based on the first waveform; and correcting the target frequency, to achieve a predetermined phase difference between the first waveform and the second waveform.

A non-transitory computer-readable medium that stores a program according to an aspect of the present disclosure causes a computer of a noise reduction device to execute: acquiring, based on a reference signal that is obtained by detecting vibration at a first position of an exhaust duct of a gas turbine, a first waveform representing vibration of the exhaust duct; acquiring, at a second position of the exhaust duct, based on a measurement signal obtained by measuring a rotation pulse of an unbalanced motor configured to apply vibration at a target frequency designated for the exhaust duct, a second waveform representing rotation of the unbalanced motor; setting the target frequency based on the first waveform; and correcting the target frequency, to achieve a predetermined phase difference between the first waveform and the second waveform.

### Advantageous Effects of Invention

With the noise reduction device, noise reduction method, and program according to the present disclosure, low frequency sound in an exhaust path of a gas turbine can be reduced.

### BRIEF DESCRIPTION OF DRAWINGS

FIG. 1 is a diagram illustrating an overall configuration of a gas turbine facility according to an embodiment of the present disclosure.

FIG. 2 is a diagram illustrating the functional configuration of a noise reduction device according to an embodiment of the present disclosure.

FIG. 3 is a flowchart illustrating an example of processing executed by the noise reduction device according to an embodiment of the present disclosure.

FIG. 4 is a first diagram illustrating a function of the noise reduction device according to an embodiment of the present disclosure.

FIG. S is a second diagram illustrating a function of the noise reduction device according to an embodiment of the present disclosure.

FIG. 6 is a diagram illustrating an example of a hardware configuration of the noise reduction device according to an embodiment of the present disclosure.

### DESCRIPTION OF EMBODIMENTS

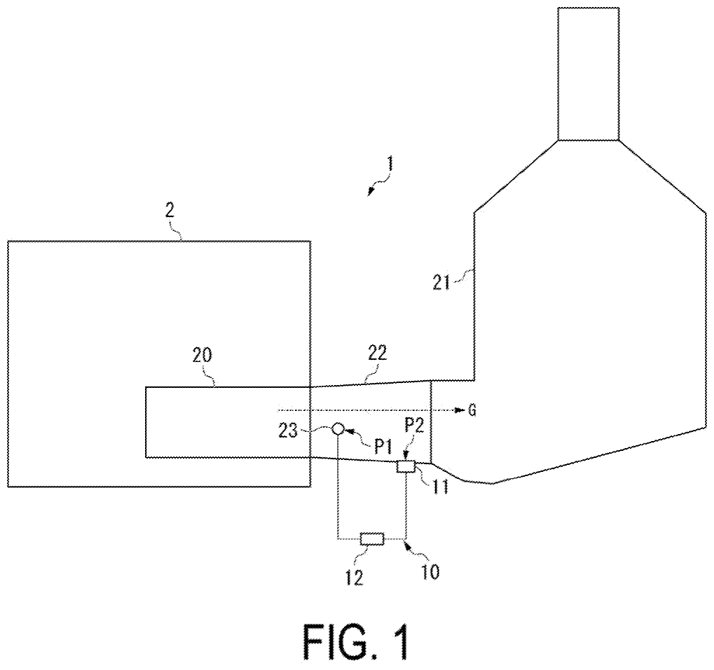

Hereinafter, a noise reduction device 10 according to an embodiment of the present disclosure will be described with reference to FIGS. 1 to 6.

### Overall Configuration

FIG. 1 is a diagram illustrating an overall configuration of a gas turbine facility according to an embodiment of the present disclosure.

As illustrated in FIG. 1, a gas turbine facility 1 includes a gas turbine 20, a waste heat recovery boiler 21 (hereinafter, also referred to as an “HRSG”), an exhaust duct 22, and the noise reduction device 10.

The gas turbine 20 is installed in a turbine building 2. The gas turbine 20 is connected to the HRSG 21 via the exhaust duct 22, and supplies produced exhaust gas G to the HRSG 21.

The HRSG 21 is installed outside the turbine building 2. The HRSG 21 uses heat of the exhaust gas G of the gas turbine 20 to produce steam.

The exhaust duct 22 connects the gas turbine 20 to the HRSG 21. outside the turbine building 2. The exhaust duct 22 is an exhaust path through which the exhaust gas G, discharged from the gas turbine 20, flows. In the following description, the gas turbine 20 side and the HRSG 21 side of the exhaust duct 22 are also referred to as “upstream side” and “downstream side”, respectively.

The noise reduction device 10 is a device that suppresses low frequency sound from the exhaust duct 22. The exhaust duct 22 may produce low frequency sound by vibrating due to radiation of combustion vibration components of the gas turbine 20. Combustion vibration occurs at the time of starting the gas turbine 20, for example. The noise reduction device 10 periodically receives a vibration waveform (reference signal) of the exhaust duct 22 from a vibration sensor 23 provided on a wall surface of the exhaust duct 22 at a first position P1. The noise reduction device 10 performs active vibration control (AVC) based on the received reference signal to reduce the vibration of the exhaust duct 22 and suppress the occurrence of low frequency sound.

The noise reduction device 10 includes an unbalanced motor 11 and a control device 12.

The unbalanced motor 11 is attached to the wall surface of the exhaust duct 22 at a second position P2. The second position P2 is, for example, a position further downstream than the first position P1, as illustrated in FIG. 1. In the unbalanced motor 11, an unbalancing weight is attached to a rotor shaft that rotates in accordance with control by the control device 12, to impart vibration to the wall surface of the exhaust duct 22.

The control device 12 measures the vibration of the exhaust duct 22 based on the reference signal from the vibration sensor 23, and controls the operation of the unbalanced motor 11 to produce vibration with which the amplitude of the waveform of this vibration can be reduced.

### Functional Configuration

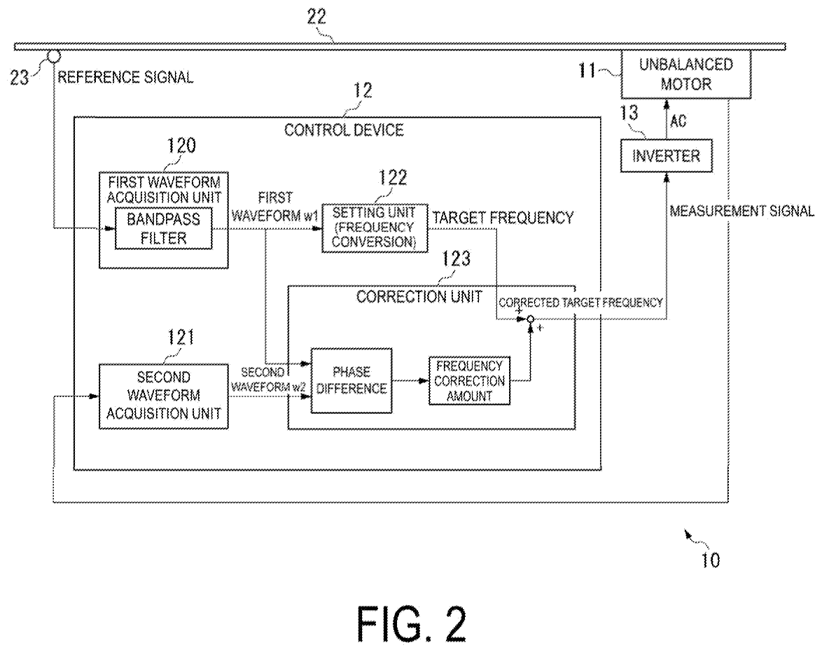

FIG. 2 is a diagram illustrating a functional configuration of a noise reduction device according to an embodiment of the present disclosure.

As illustrated in FIG. 2, power for driving is supplied to the unbalanced motor 11 of the noise reduction device 10 through an inverter 13. The control device 12 of the noise reduction device 10 rotates the unbalanced motor 11 at any appropriate frequency (target frequency described below) under inverter control. The control device 12 includes a first waveform acquisition unit 120, a second waveform acquisition unit 121, a setting unit 122, and a correction unit 123.

The first waveform acquisition unit 120 acquires a first waveform w1 representing the vibration of the exhaust duct 22 based on the reference signal from the vibration sensor 23.

The second waveform acquisition unit 121 acquires a second waveform w2 representing the rotation of the unbalanced motor 11 based on a measurement signal obtained by measuring a rotation pulse of the unbalanced motor 11.

The setting unit 122 acquires the vibration frequency of the exhaust duct 22 from the first waveform w1 and sets the target frequency of the unbalanced motor 11 based on this vibration frequency.

The correction unit 123 corrects the target frequency of the unbalanced motor 11, to achieve a predetermined phase difference between the first waveform w1 and the second waveform w2. When the rotation frequency (second waveform w2) of the unbalanced motor 11 is closer to the phase opposite to that of the vibration frequency (first waveform w1) of the exhaust duct 22, the vibration of the exhaust duct 22 is more offset by the vibration of the unbalanced motor 11 to be smaller. In view of this, the correction unit 123 sets the predetermined phase difference to 180 degrees, for example. Note that the correction unit 123 may set the predetermined phase difference to be in a certain range such as 180±α degrees.

The target frequency corrected by the correction unit 123 (corrected target frequency) is output to the inverter 13. The inverter 13 outputs AC voltage corresponding to the corrected target frequency to the unbalanced motor 11, to rotate the unbalanced motor 11 at the corrected target frequency. Note that the inverter 13 may be incorporated in the unbalanced motor 11.

### Processing Flow

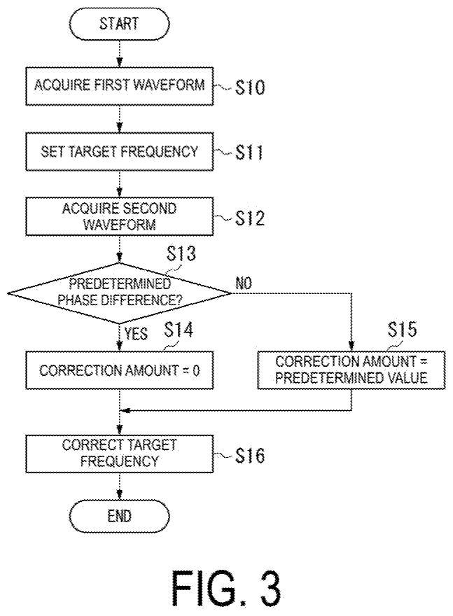

FIG. 3 is a flowchart illustrating an example of processing executed by the noise reduction device according to an embodiment of the present disclosure.

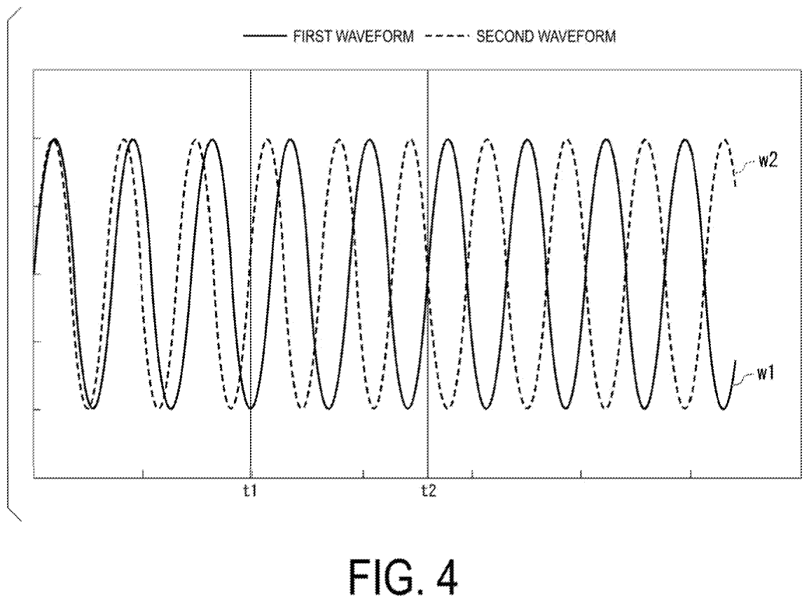

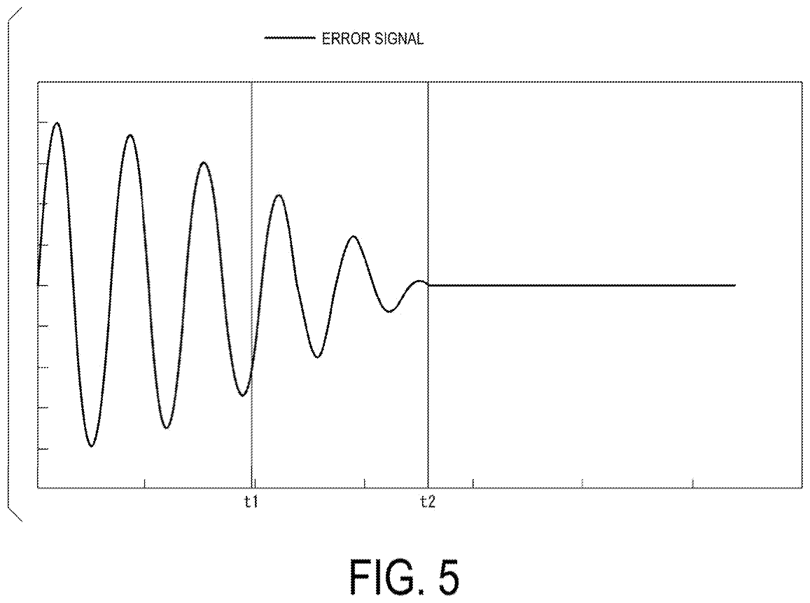

FIG. 4 is a first diagram illustrating a function of the noise reduction device according to an embodiment of the present disclosure.

FIG. 5 is a second diagram illustrating a function of the noise reduction device according to an embodiment of the present disclosure.

Hereinafter, processing executed by the noise reduction device 10 will be described in detail with reference to FIGS. 3 to 5.

First, the first waveform acquisition unit 120 of the control device 12 acquires the first waveform w1 representing the vibration of the exhaust duct 22 based on the reference signal received from the vibration sensor 23 (step S10). Specifically, the first waveform acquisition unit 120 removes unnecessary frequency band components such as noise from the reference signal by using a bandpass filter (FIG. 2). As a result, as illustrated in FIG. 4, the first waveform acquisition unit 120 can acquire the first waveform w1, which is a waveform of the component related to the vibration of the exhaust duct 22.

Subsequently, the setting unit 122 of the control device 12 sets the target frequency of the unbalanced motor 11 based on the first waveform w1 (step S11). For example, the setting unit 122 sets the target frequency to be a value equal to the vibration frequency of the exhaust duct 22.

Based on the measurement signal (rotation pulse) received from the unbalanced motor 11, the second waveform acquisition unit 121 of the control device 12 acquires the second waveform w2 (FIG. 4) representing the rotation of the unbalanced motor 11 (step S12).

Subsequently, the correction unit 123 of the control device 12 determines whether a phase difference between the first waveform w1 and the second waveform w2 is the predetermined phase difference (step S13).

When the phase difference between the first waveform w1 and the second waveform w2 is not the predetermined phase difference (when the phase difference is outside the range of 180±α degrees, for example) (step S13: NO), the correction unit 123 sets a correction amount for the target frequency to a predetermined value (step S15). The predetermined value is any value designated by a manager or the like of the gas turbine facility 1, and is, for example, 0.1 Hz.

On the other hand, when the phase difference between the first waveform w1 and the second waveform w2 is the predetermined phase difference (when the phase difference is within the range of 180±α degrees. for example) (step S13: YES), the correction unit 123 sets the correction amount for the target frequency to zero (step S14).

Subsequently, the correction unit 123 corrects the target frequency with the set correction amount (step S16). The target frequency corrected by the correction unit 123 (corrected target frequency) is output to the inverter 13. The inverter 13 outputs the AC voltage to the unbalanced motor 11 such that the unbalanced motor 11 rotates at the corrected target frequency.

The control device 12 periodically executes the series of processes in FIG. 3 to control the unbalanced motor 11 and thereby reduce the vibration of the exhaust duct 22.

For example, at a time point t1 in FIG. 4, a phase difference between the first waveform w1 and the second waveform w2 is not the predetermined phase difference (opposite phases) (step S13: NO). Thus, the correction unit 123 causes the unbalanced motor 11 to rotate at the corrected frequency calculated by adding the correction amount (0.1 Hz) to the target frequency, to obtain the second waveform w2 shifted by the correction amount from the target frequency (steps S15 and S16). The control device 12 can repeatedly execute these processes to correct the phase shift of the second waveform w2, thereby bringing the phase of the second waveform w2 closer to a phase opposite to that of the first waveform w1.

At a time point t2 in FIG. 4, the predetermined phase difference (opposite phase) is achieved between the first waveform w1 and the second waveform w2 (step S13: YES), Here, the correction unit 123 sets the correction amount to zero, and causes the unbalanced motor 11 to rotate at the target frequency set by the setting unit 122 (steps S14 and S16), As a result, the unbalanced motor 11 applies the vibration with the phase opposite to that of the vibration of the exhaust duct 22 to offset the vibration of the exhaust duct 22. Thus, the vibration of the exhaust duct 22 can be reduced.

FIG. 5 illustrates an example where the effect of the noise reduction device 10 is measured based on an error signal received from a vibration sensor (not illustrated) provided in the vicinity of the second position P2 of the exhaust duct 22. The time points t1 and t2 in FIG. 5 are the same times as the time points t1 and t2 in FIG. 4, respectively. At the time point t1, the phase of the second wavefront w2 (FIG. 4) is not opposite to that of the first waveform w1. Thus, as illustrated in FIG. 5, at the time point t1, the vibration damping effect of the unbalanced motor 11 is relatively small, and the vibration of the exhaust duct 22 is detected.

On the other hand, at and after the time point t2, the phase of the second waveform w2 (FIG. 4) is opposite to that of the first waveform w1. Thus, as illustrated in FIG. 5, at the time point t2, the damping effect of the unbalanced motor 11 is greater than that at the time point t1, and the vibration of the exhaust duct 22 is significantly reduced.

### Hardware Configuration

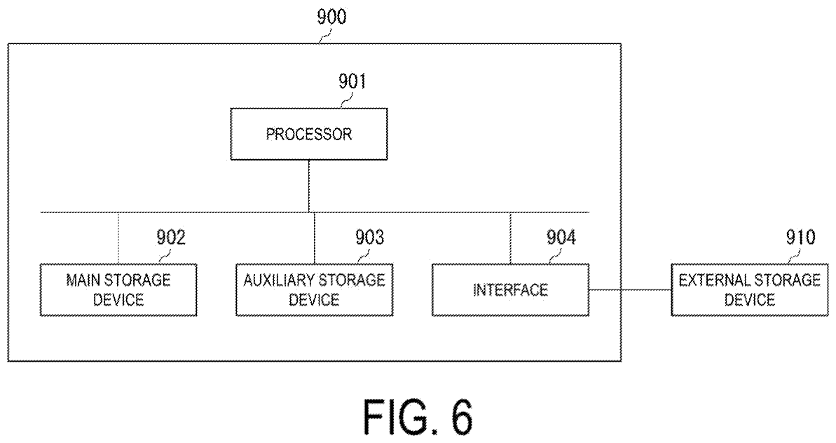

FIG. 6 is a diagram illustrating an example of a hardware configuration of the noise reduction device according to an embodiment of the present disclosure.

The hardware configuration of the noise reduction device 10 according to the present embodiment will be described below with reference to FIG. 6.

A computer 900 includes a processor 901, a main storage device 902. an auxiliary storage device 903, and an interface 904.

The noise reduction device 10 (control device 12) described above is implemented in one or a plurality of computers 900. In this configuration, the operations of each respective functional unit described above are stored in the auxiliary storage device 903 as programs. The processor 901 reads out the programs from the auxiliary storage device 903, deploys the programs to the main storage device 902, and executes the above-described processing in accordance with the programs. Further, the processor 901 secures storage areas corresponding to the respective storage units described above in the main storage device 902 in accordance with the programs. Examples of the processor 901 include a central processing unit (CPU), a graphics processing unit (OPU), and a microprocessor.

The program may be a program for achieving some of the functions that the computer 900 is caused to perform. For example, the program may be a program that achieves a function in combination with another program already stored in the auxiliary storage device 903, or in combination with another program installed on another device. Note that, in other embodiments, the computer 900 may include a custom large scale integrated circuit (LSD) such as a programmable logic device (PLD), in addition to or in place of the configuration described above.

Examples of the PLD include a programmable array logic (PAL), a generic array logic (GAL), a complex programmable logic device (CPLD), and a field programmable gate array (FPGA). In this case, some or all of the functions achieved by the processor 901 may be achieved by the integrated circuit. Such integrated circuits are also included in an example of the processor.

Examples of the auxiliary storage device 903 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The auxiliary storage device 903 may be an internal medium directly connected to a bus of the computer 900, or may be an external storage device 910 connected to the computer 900 via the interface 904 or a communication line. Further, when this program is distributed to the computer 900 through a communication line, the computer 900 receiving the distribution may deploy the program to the main storage device 902, and may execute the above-mentioned processing. In at least one of the embodiments, the auxiliary storage device 903 is a non-temporary tangible storage medium.

Furthermore, the program may be for achieving some of the functions described above.

In addition, the program may achieve the functions described above in combination with other programs already stored in the auxiliary storage device 903, that is, may be differential files (differential programs).

### Operational Effects

As described above, the noise reduction device 10 according to the present embodiment includes: the first waveform acquisition unit 120 that acquires the first waveform w1 representing the vibration at the first position P1 of the exhaust duct 22; the unbalanced motor 11 that applies the vibration at the target frequency to the exhaust duct 22, at the second position P2 of the exhaust duct 22; the second waveform acquisition unit 121 that acquires the second waveform w2 representing the rotation of the unbalanced motor 11; the setting unit 122 that sets the target frequency based on the first waveform w1; and the correction unit 123 that corrects the target frequency to achieve the predetermined phase difference between the first waveform w1 and the second waveform w2.

With this configuration, the noise reduction device 10 can adjust the target frequency of the unbalanced motor 11, so that the unbalanced motor 11 can produce vibration with which the vibration of the exhaust duct 22 can be reduced.

When a phase difference between the first waveform w1 and the second waveform w2 is not the predetermined phase difference, the correction unit 123 corrects the target frequency by adding the predetermined correction amount.

With this configuration, the noise reduction device 10 can easily adjust the phase difference between the first waveform w1 and the second waveform w2 by correcting the target frequency of the unbalanced motor 11 by individual predetermined amounts (0.1 Hz, for example). Even when the vibration frequency of the exhaust duct 22 changes, the noise reduction device 10 can successively adjust the target frequency of the unbalanced motor 11 to follow this change.

When the predetermined phase difference is achieved between the first waveform w1 and the second waveform w2, the correction unit 123 sets the correction amount to zero.

With this configuration, the noise reduction device 10 can operate the unbalanced motor 11, with the target frequency automatically set by the setting unit 122 fixed, at and after the timing when the phase difference between the first waveform w1 and the second waveform w2 has entered an appropriate state (180±α a degrees, for example).

In the foregoing, embodiments of the present disclosure have been described, but all of these embodiments are merely illustrative and are not intended to limit the scope of the invention. These embodiments may be implemented in various other forms, and various omissions, substitutions, and alterations may be made without departing from the gist of the invention. These embodiments and modifications are included in the scope and gist of the invention and are also included in the scope of the invention described in the claims and equivalents thereof.

For example. in the embodiment described above, an example is described where the first waveform acquisition unit 120 of the noise reduction device 10 (control device 12) receives the vibration waveform of the exhaust duct 22 from the vibration sensor 23 of the exhaust duct 22 as the reference signal. However, this should not be construed in a limiting sense. The reference signal may be any sensor signal with which the combustion vibration of the gas turbine 20 can be detected. For example, the first waveform acquisition unit 120 according to another embodiment may receive a reference signal indicating pressure variation from a pressure sensor installed in the exhaust duct 22.

### Notes

A noise reduction device, a noise reduction method, and a program described in the above embodiment can be understood as follows, for example.

(1) According to a first aspect of the present disclosure, a noise reduction device (10) includes: a first waveform acquisition unit (120) configured to acquire, based on a reference signal that is obtained by detecting vibration at a first position of an exhaust duct (22) of a gas turbine (20), a first waveform (w1) representing vibration of the exhaust duct (22); an unbalanced motor (11) configured to apply, at a second position of the exhaust duct (22). vibration at a target frequency designated for the exhaust duct (22); a second waveform acquisition unit (121) configured to acquire, based on a measurement signal obtained by measuring a rotation pulse of the unbalanced motor (11), a second waveform (w2) representing rotation of the unbalanced motor (11); a setting unit (122) configured to set the target frequency based on the first waveform (w1); and a correction unit (123) configured to correct the target frequency, to achieve a predetermined phase difference between the first waveform (w1) and the second waveform (w2).

With this configuration, the noise reduction device can adjust the target frequency of the unbalanced motor, so that the unbalanced motor can produce vibration with which the vibration of the exhaust duct can be reduced.

(2) According to a second aspect of the present disclosure, in the noise reduction device (10) according to the first aspect, when a phase difference between the first waveform (w1) and the second waveform (w2) is not the predetermined phase difference, the correction unit (123) corrects the target frequency by adding a predetermined correction amount.

With this configuration, the noise reduction device can easily adjust the phase difference between the first waveform and the second waveform, by correcting the target frequency of the unbalanced motor by individual predetermined amounts. Even when the vibration frequency of the exhaust duct changes. the noise reduction device can successively adjust the target frequency of the unbalanced motor to follow this change.

(3) According to a third aspect of the present disclosure, in the noise reduction device (10) according to the first aspect, when the predetermined phase difference is achieved between the first waveform (w1) and the second waveform (w2), the correction unit (123) sets a correction amount for the target frequency to zero.

With this configuration, the noise reduction device can operate the unbalanced motor, with the target frequency automatically set by the setting unit fixed, at and after the timing when the phase difference between the first waveform and the second waveform has entered an appropriate state.

(4) According to a fourth aspect of the present disclosure, a noise reduction method includes: acquiring, based on a reference signal that is obtained by detecting vibration at a first position of an exhaust duct (22) of a gas turbine (20), a first waveform (w1) representing vibration of the exhaust duct (22); applying, by an unbalanced motor (11) provided at a second position of the exhaust duct (22), vibration at a target frequency designated for the exhaust duct (22); acquiring, based on a measurement signal obtained by measuring a rotation pulse of the unbalanced motor (11), a second waveform (w2) representing rotation of the unbalanced motor (11); setting the target frequency based on the first waveform (w1); and correcting the target frequency, to achieve a predetermined phase difference between the first waveform (w1) and the second waveform (w2).

(5) According to a fifth aspect of the present disclosure, a non-transitory computer-readable medium that stores a program causes a computer (900) of a noise reduction device (10) to execute; acquiring, based on a reference signal that is obtained by detecting vibration at a first position of an exhaust duct (22) of a gas turbine (20), a first waveform (w1) representing vibration of the exhaust duct (22); acquiring, at a second position of the exhaust duct (22), based on a measurement signal obtained by measuring a rotation pulse of an unbalanced motor (11) configured to apply vibration at a target frequency designated for the exhaust duct (22), a second waveform (w2) representing rotation of the unbalanced motor (11); setting the target frequency based on the first waveform (w1); and correcting the target frequency, to achieve a predetermined phase difference between the first waveform (w1) and the second waveform (w2).

### INDUSTRIAL APPLICABILITY

With the noise reduction device, noise reduction method, and program according to the present disclosure, low frequency sound in an exhaust path of a gas turbine can be reduced.

### REFERENCE SIGNS LIST

1 Gas turbine facility
10 Noise reduction device
11 Unbalanced motor
12 Control device
120 First waveform acquisition unit
121 Second waveform acquisition unit
122 Setting unit
123 Correction unit
13 Inverter
2 Turbine building
20 Gas turbine
21 Waste heat recovery boiler (HRSG)
22 Exhaust duct
23 Vibration sensor
900 Computer
901 Processor
902 Main storage device
903 Auxiliary storage device
904 Interface
910 External storage device
w1 First waveform
w2 Second waveform

What is claimed is:

1. A noise reduction device comprising:
a first waveform acquisition unit configured to acquire, based on a reference signal that is obtained by detecting vibration at a first position of an exhaust duct of a gas turbine, a first waveform representing vibration of the exhaust duct:
an unbalanced motor configured to apply, at a second position of the exhaust duct, vibration at a target frequency designated for the exhaust duct;
a second waveform acquisition unit configured to acquire, based on a measurement signal obtained by measuring a rotation pulse of the unbalanced motor, a second waveform representing rotation of the unbalanced motor;
a setting unit configured to set the target frequency based on the first waveform; and
a correction unit configured to correct the target frequency, to achieve a predetermined phase difference between the first waveform and the second waveform.

2. The noise reduction device according to claim 1, wherein
when a phase difference between the first waveform and the second waveform is not the predetermined phase difference, the correction unit corrects the target frequency by adding a predetermined correction amount.

3. The noise reduction device according to claim 1, wherein
when the predetermined phase difference is achieved between the first waveform and the second waveform, the correction unit sets a correction amount for the target frequency to zero.

4. A noise reduction method comprising:
acquiring, based on a reference signal that is obtained by detecting vibration at a first position of an exhaust duct of a gas turbine, a first waveform representing vibration of the exhaust duct;
applying, by an unbalanced motor provided at a second position of the exhaust duct, vibration at a target frequency designated for the exhaust duct;
acquiring, based on a measurement signal obtained by measuring a rotation pulse of the unbalanced motor, a second waveform representing rotation of the unbalanced motor;
setting the target frequency based on the first waveform; and
correcting the target frequency, to achieve a predetermined phase difference between the first waveform and the second waveform.

5. A non-transitory computer-readable medium that stores a program causing a computer of a noise reduction device to execute:
acquiring, based on a reference signal that is obtained by detecting vibration at a first position of an exhaust duct of a gas turbine, a first waveform representing vibration of the exhaust duct;
acquiring, at a second position of the exhaust duct, based on a measurement signal obtained by measuring a rotation pulse of an unbalanced motor configured to apply vibration at a target frequency designated for the exhaust duct, a second waveform representing rotation of the unbalanced motor:
setting the target frequency based on the first waveform; and
correcting the target frequency, to achieve a predetermined phase difference between the first waveform and the second waveform.
